(19) United States
(12) Patent Application Publication
(10) Pub. No.: US 2009/0012733 A1
(43) Pub. Date: Jan. 8, 2009

(54) OFFSET CORRECTION PROGRAM AND ELECTRONIC COMPASS

(75) Inventors: Yukimitsu Yamada, Miyagi-ken (JP); Kisei Hirobe, Miyagi-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/205,555

(22) Filed: Sep. 5, 2008

Related U.S. Application Data
(63) Continuation of application No. PCT/JP2007/053576, filed on Feb. 27, 2007.

(30) Foreign Application Priority Data
Mar. 6, 2006 (JP) 2006-059815
Aug. 14, 2006 (JP) 2006-220876

(51) Int. Cl. G01C 17/38

(52) U.S. Cl. 702/92

(57) ABSTRACT

When an external magnetic field is applied to a sensor unit 12 for various causes, a characteristics curve does not pass through an intersection point of resistance (voltage) and a magnetic field and is offset. That is, an offset voltage (Roff) occurs. In the present invention, in order to determine a correction value for canceling the offset voltage, a difference between output voltages is determined from two stages in which a bias magnetic field is inverted, and the bias magnetic field is controlled until the difference becomes approximately zero. Then, the corresponding bias magnetic field (the electrical current value) when the difference between the output voltages becomes approximately zero is set as a correction value (correction bias). As a result, since correction can be performed even if an offset voltage is applied, it is possible to accurately perform magnetic detection.

### CLAIM OF PRIORITY

This is a continuation of International Application No. PCT/JP2007-053576, filed Feb. 27, 2007, which is incorporated herein by reference in its entirety.

### BACKGROUND OF THE INVENTION

1. Field of the Invention

The present invention relates to an offset correction program for correcting an offset to be applied to a magnetic sensor and an electronic compass including the offset correction program.

2. Description of the Related Art

When direction measurement is to be performed electronically, this is performed using a magnetic sensor for detecting an external magnetic field, such as the geomagnetism. A technology is known in which, when a direction is to be determined using a magnetic detection circuit including a magnetic sensor, an alternating-current magnetic field is applied to the magnetic sensor, and a voltage output from the magnetic sensor when the alternating-current magnetic field is applied is used.

In this technology, magnetic sensors including a magnetoresistive element whose internal resistance is changed when a magnetic field is applied are used. This magnetoresistive element shows changes in resistance that are symmetrical with respect to a magnetic field. When an alternating-current magnetic field is superposed to a magnetoresistive element to which an external magnetic field such as the geomagnetism is applied, it is possible to detect changes in the resistance value by using characteristics of the magnetoresistive element. Then, by applying an electrical current in a direction in which the external magnetic field is cancelled, it is possible to measure an electrical current corresponding to the external magnetic field. The strength of the external magnetic field can be determined on the basis of the electrical current value.

### SUMMARY OF THE INVENTION

For example, when an electronic compass using the above-described magnetic detection circuit is installed in a mobile phone or the like, there is a problem of not capable of accurately performing magnetic detection by being influenced of magnetic noise (hereinafter abbreviated as a “leakage magnetic field”) other than the geomagnetism generated from an electronic part installed in a mobile phone, such as a speaker.

An object of the present invention is to provide an electronic compass capable of correcting an offset to be applied to a magnetic sensor and accurately performing magnetic detection even in an environment in which a leakage magnetic field exists.

The offset correction program of the present invention is a computer-executable offset correction program for correcting an offset to be applied to a magnetic sensor, the offset correction program including: the step of determining a first linear expression on the basis of at least two first output voltages obtained by applying to the magnetic sensor a bias magnetic field in a state in which a first polarity thereof is applied and inverted; the step of determining a second linear expression on the basis of at least two second output voltages obtained by applying to the magnetic sensor a bias magnetic field in a state in which a second polarity thereof is applied and inverted; and the step of determining a correction value on the basis of an intersection point of the first linear expression and the second linear expression.

With this configuration, it is possible to eliminate an offset voltage that is inevitably generated in a voltage output from an amplifier in the magnetic detection circuit. As a result, it is possible to accurately perform magnetic detection even in an environment in which a leakage magnetic field exists.

The offset correction program of the present invention preferably includes the step of correcting sensitivity of the magnetic sensor by using the first linear expression and the second linear expression.

The electronic compass of the present invention includes a compass module having a magnetic sensor and control means having the offset correction program for detecting the geomagnetism by using the output of the magnetic sensor and a direction computation program for determining a direction.

In the electronic compass of the present invention, the magnetic sensor preferably includes a magnetoresistive element that shows changes in resistance that occur monotonically with a magnetic field. In this case, the magnetoresistive element is preferably a GMR element. Furthermore, In the electronic compass of the present invention, the magnetic sensor is preferably formed of a bridge circuit.

### BRIEF DESCRIPTION OF THE DRAWINGS

FIG. 1 is a block diagram showing a schematic configuration of an electronic compass including an offset correction program according to an embodiment of the present invention.

FIG. 2(a) is a circuit diagram showing stage S1 of a magnetic detection apparatus shown in FIG. 1, and FIG. 2(b) shows changes in resistance of a magnetoresistive element.

FIG. 3(a) is a circuit diagram showing stage S2 of the magnetic detection apparatus shown in FIG. 1, and FIG. 3(b) shows changes in resistance of a magnetoresistive element.

FIG. 4(a) is a circuit diagram showing stage S3 of the magnetic detection apparatus shown in FIG. 1, and FIG. 4(b) shows changes in resistance of a magnetoresistive element.

FIG. 5(a) is a circuit diagram showing stage S4 of the magnetic detection apparatus shown in FIG. 1, and FIG. 5(b) shows changes in resistance of a magnetoresistive element.

FIG. 6 illustrates the correction principle of the magnetic detection apparatus according to the embodiment of the present invention.

### DESCRIPTION OF THE PREFERRED EMBODIMENTS

When a magnetoresistive element that shows changes in resistance that occur monotonically with a magnetic field is to be used, first, a bias magnetic field of one of the polarities is applied to invert the polarity of a voltage to be applied to the magnetoresistive element, thereby determining a voltage value corresponding to another magnetic field. Next, a bias magnetic field of the other polarity is applied to invert the polarity of a voltage to be applied to the magnetoresistive element, thereby determining a voltage value corresponding to another magnetic field. The two voltage values each contain an offset voltage. Therefore, by determining a difference between the voltage values corresponding to the other respective magnetic fields, which are determined in this manner, a voltage value corresponding to another magnetic field can be determined in a state in which the offset voltage is cancelled. As a result, magnetic detection in a state in which there is no offset voltage can be performed.

An embodiment of the present invention will be described in detail below with reference to the attached drawings. In this embodiment, a case in which only the offset voltage of an amplifier 132 is eliminated will be described.

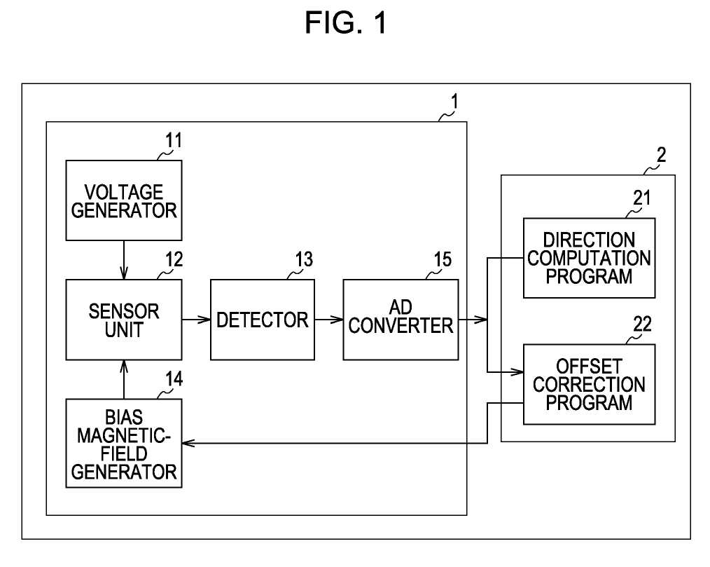

FIG. 1 is a block diagram showing a schematic configuration of an electronic compass including an offset correction program according to an embodiment of the present invention. The electronic compass shown in FIG. 1 mainly includes a compass module 1 and a controller 2. The compass module 1 mainly includes a sensor unit 12 for outputting a voltage value corresponding to changes in the geomagnetism, a voltage generator 11 for applying a voltage to the sensor unit 12, a bias magnetic-field generator 14 for applying a bias magnetic field to the sensor unit 12, a detector 13 for detecting (amplifying) the voltage value output by the sensor unit 12, and an AD converter 15 for converting the voltage value from analog into digital form. The controller 2 includes a direction computation program 21 for determining a direction by using the output of the sensor unit 12 and an offset correction program 22 for performing offset correction by using the output of the sensor unit 12.

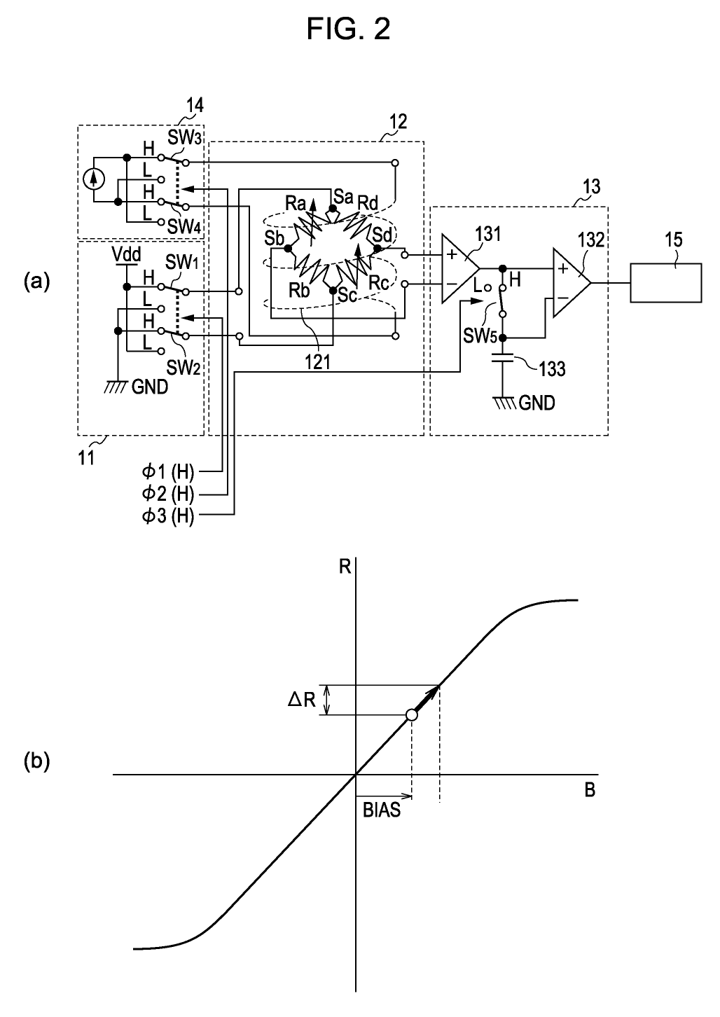

The voltage generator 11 switches a voltage to be applied to the sensor unit 12. In this embodiment, as shown in FIG. 2(a), the voltage generator 11 is formed of switches SW₁ and SW₂ that are connected to the bridge circuit of the sensor unit 12. The timing at which the voltage is switched is controlled by a controller (not shown) of the compass module 1.

The sensor unit 12 is formed of three axes of the X axis, the Y axis, and the Z axis, and has a magnetic sensor including a magnetic effect element that detects the geomagnetism, and outputs a voltage value corresponding to changes in the geomagnetism. In this embodiment, as shown in FIG. 2(a), the sensor unit 12 is formed of a bridge circuit. As the magnetic effect element, a magnetoresistive element that shows changes in resistance that occur monotonically with a magnetic field is used. Examples of such a magnetic effect element include an MR element, such as a giant magnetoresistive (GMR) element, an anisotropic magnetoresistive (AMR) element, or a tunnel magnetoresistive (TMR) element.

The bias magnetic-field generator 14 switches a bias magnetic field to be applied to the sensor unit 12 by supplying to the sensor unit an electrical current used to generate a bias magnetic field whose polarity is inverted. In this embodiment, as shown in FIG. 2(a), the bias magnetic-field generator 14 is formed of switches SW₃ and SW₄ connected to the bridge circuit of the sensor unit 12. The timing at which this bias magnetic field is switched is controlled by a controller (not shown) of the compass module 1.

The detector 13 detects (amplifies) the voltage value output by the sensor unit 12. In this embodiment, as shown in FIG. 2(a), the detector 13 includes an amplifier 131, an amplifier 132 for amplifying a voltage value, a capacitor 133 for storing a voltage value, and a switch SW₅ for switching as to whether to be stored in the capacitor 133. The timing at which this voltage value is stored is controlled by a controller (not shown) of the compass module 1.

The controller 2 includes at least a direction computation program 21 and an offset correction program 22 as driver software for driving the compass module 1. The method of the direction computation program 21 is not particularly limited as long as an azimuth with respect to a reference direction can be determined on the basis of information on the geomagnetism obtained using the compass module 1. For example, the sensor unit 12 is formed of three axes of the X axis, the Y axis, and the Z axis. Accordingly, the sensor unit 12 computes a direction by using the geomagnetism for the X axis, the geomagnetism for the Y axis, and the geomagnetism for the Z axis, which are determined by an geomagnetism detection process. More specifically, the direction is computed by calculating an arctangent with respect to the ratio of an output voltage corresponding to the geomagnetism for the X axis to an output voltage corresponding to the geomagnetism for the Y axis. Furthermore, the voltage corresponding to the geomagnetism for the Z axis is used in a computation of correcting a state in which the electronic compass is inclined. For example, when the electronic compass according to the present invention is installed in a mobile phone or the like, it is expected that the mobile phone is used in a state in which the electronic compass is inclined. In such a case, a correction computation is performed using the geomagnetism for the Z axis in order to compute the direction.

The offset correction program 22 is a program capable of, when an external magnetic field other than the geomagnetism is applied to the magnetic sensor, correcting an offset thereof. When a magnetized component exists in the vicinity of a device installed with the compass module 1, an offset is added to the output from the sensor unit 12, and the geomagnetism is not accurately detected. According to this offset correction program, it is possible to determine the amount of correction for an offset due to an external magnetic field (leakage magnetic field) by using element characteristics of the magnetic sensor.

The offset correction program 22 is a computer-executable offset correction program for correcting an offset to be applied to a magnetic sensor, the offset correction program including: the step of determining a first linear expression on the basis of at least two first output voltages obtained by applying to the magnetic sensor a bias magnetic field in a state in which a first polarity thereof is applied and inverted; the step of determining a second linear expression on the basis of at least two second output voltages obtained by applying to the magnetic sensor a bias magnetic field in a state in which a second polarity thereof is applied and inverted; and the step of determining a correction value on the basis of an intersection point of the first linear expression and the second linear expression.

Next, the operation of the magnetic detection apparatus of the present invention will be described with reference to a circuit diagram shown in FIG. 2(a). FIG. 2(a) is a circuit diagram showing an electronic compass according to an embodiment of the present invention. In FIG. 2(a), for simplicity of description, input of a control signal is shown without showing a controller.

In this embodiment, as shown in FIG. 2(b), a magnetoresistive element used in the sensor unit 12 exhibits a magnetic resistance effect that shows changes in resistance that occur monotonically with a magnetic field (in FIG. 2(b), increases monotonically). When a bias magnetic field is applied to this magnetoresistive element, the resistance changes due to a bias magnetic field, as shown in FIG. 2(b). Then, in this state, when another external magnetic field, such as the geomagnetism, is applied to the magnetoresistive element, the resistance value is changed. When the direction of the other magnetic field is the same as the direction of the bias magnetic field, the resistance value increases, and when they differ, the resistance value decreases.

In this embodiment, the sensor unit 12 is formed of a bridge circuit. In the bridge circuit of FIG. 2(a), elements that show magnetic changes in resistance are Ra and Rc. Furthermore, reference letters Rb and Rd each denote a fixed resistor. When a voltage is applied to a pair of terminals Sa and Sc of the bridge circuit, a voltage divided by each resistor is output from a pair of terminals Sb and Sd on the opposite side. Since the resistance of the elements Ra and Rc constituting the bridge circuit is changed due to a magnetic field, a voltage is output in response to the magnetic field.

In this embodiment, the voltage generator 11 is formed of switches SW₁ and SW₂, and the polarity (direction) of the voltage to be applied to the sensor unit 12 is switched in accordance with a control signal φ1. When the control signal φ1 is high (H signal), the switches SW₁ and SW₂ cause Vdd to be connected to the terminal Sa side, so that a voltage is applied in the direction from the terminal Sa to the terminal Sd. When the control signal φ1 is low (L signal), the switches SW₁ and SW₂ cause Vdd to be connected to the terminal Sd side, so that a voltage is applied in the direction from the terminal Sd to the terminal Sa.

As shown in FIG. 2(a), the bias magnetic-field generator 14 switches the direction of the electrical current that is made to flow to a coil 121 mounted in the sensor unit 12 in accordance with a control signal φ2, so that a bias magnetic field whose polarity is inverted is applied to the sensor unit 12. When the control signal φ2 is high (H signal), switches SW₃ and SW₄ cause electrical current to flow in a clockwise manner when viewed from the above, and a bias magnetic field is generated in a positive direction in the sensor unit 12. When the control signal φ2 is low (L signal), the switches SW₃ and SW₄ cause electrical current to flow in a direction opposite to the above, and a bias magnetic field is generated in a negative direction in the sensor unit 12.

In the computation unit 13, the amplifier 131 is connected to the terminals Sb and Sd of the bridge circuit and receives the output of the sensor unit 12. The received voltage is charged in the capacitor 133 via the switch SW₅. Furthermore, the received voltage is connected to the input terminal of the amplifier 132. The switch SW₅ is controlled in accordance with a control signal φ3. When the control signal φ3 is high (H signal), the switch SW₅ causes the output of the amplifier 131 to be connected to the capacitor 133. When the control signal φ3 is low (L signal), the switch SW₅ releases the connection with the capacitor 133. The amplifier 132 operates so as to amplify the difference between the voltage value of the capacitor 133 and the voltage value that is the output of the amplifier 131. As a result, the difference between the voltage values when the direction of the bias magnetic field to be applied to the sensor unit 12 is switched is amplified and output.

Next, the operation of the magnetic detection apparatus having the above-described configuration will be described. It is assumed that the bias magnetic field in the same direction as that of the magnetic field of the magnetic (the geomagnetism) to be detected is in a positive direction.

The driving mode in the sensor unit 12 of the electronic compass according to this embodiment is formed of the following four stages:
S1: voltage is positive and bias magnetic field is positive
S2: voltage is negative and bias magnetic field is positive
S3: voltage is positive and bias magnetic field is negative
S4: voltage is negative and bias magnetic field is negative.

As shown in FIG. 2(a), in stage S1, a voltage to be applied to the sensor unit 12 is positive (the control signal φ1 is an H signal), and a bias magnetic field to be applied to the sensor unit 12 is positive (the control signal φ2 is an H signal). For this reason, the changes in resistance of the magnetoresistive element are as shown in FIG. 2(b). In stage S1, the control signal φ3 is an H signal, and the switch SW₅ causes the output of the amplifier 131 to be connected to the capacitor 133.

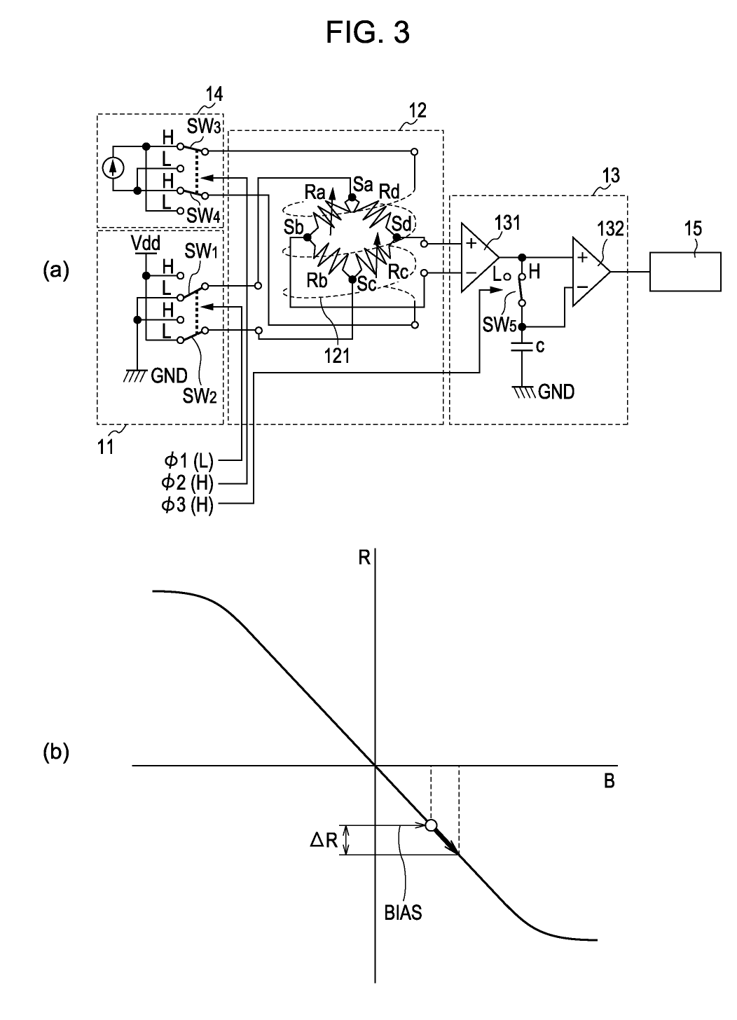

In stage S2, as shown in FIG. 3(a), the voltage to be applied to the sensor unit 12 is negative (the control signal φ1 is an L signal), and the bias magnetic field to be applied to the sensor unit 12 is positive (the control signal φ2 is an H signal). For this reason, the changes in resistance of the magnetoresistive element are as shown in FIG. 3(b). In stage S2, the control signal φ3 is an H signal, and the switch SW₅ causes the output of the amplifier 131 to be connected to the capacitor 133.

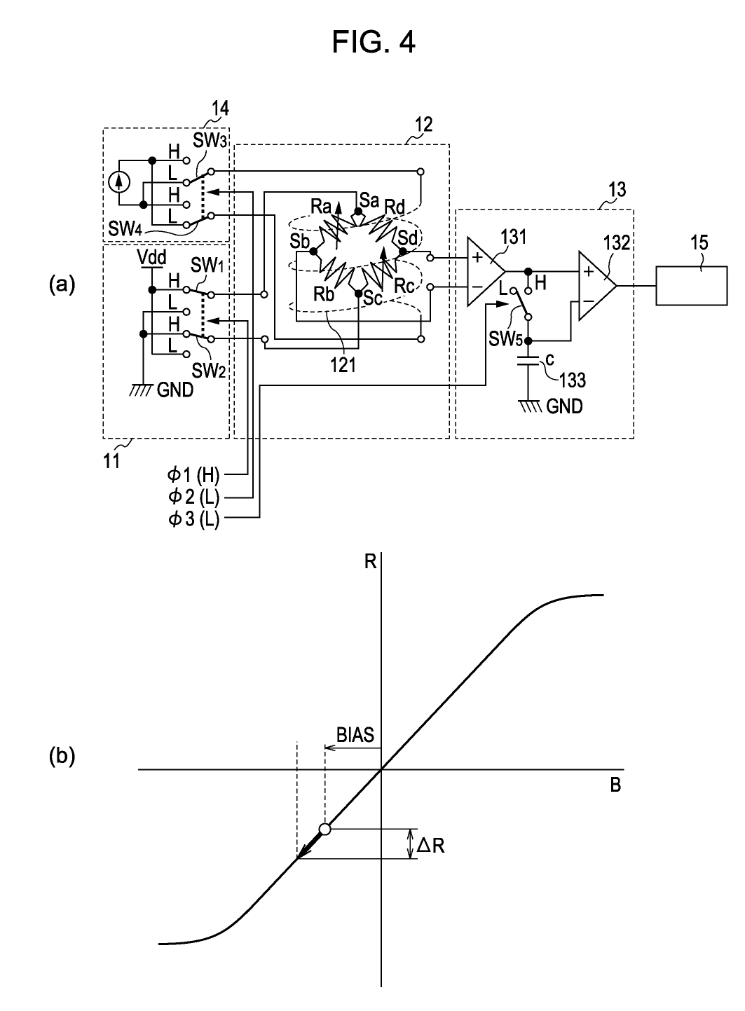

In stage S3, as shown in FIG. 4(a), the voltage to be applied to the sensor unit 12 is positive (the control signal φ1 is an H signal), and the bias magnetic field to be applied to the sensor unit 12 is negative (the control signal φ2 is an L signal). For this reason, the changes in resistance of the magnetoresistive element are as shown in FIG. 4(b). In stage S3, the control signal φ3 is an L signal, and the switch SW₅ does not cause the output of the amplifier 131 to be connected to the capacitor 133.

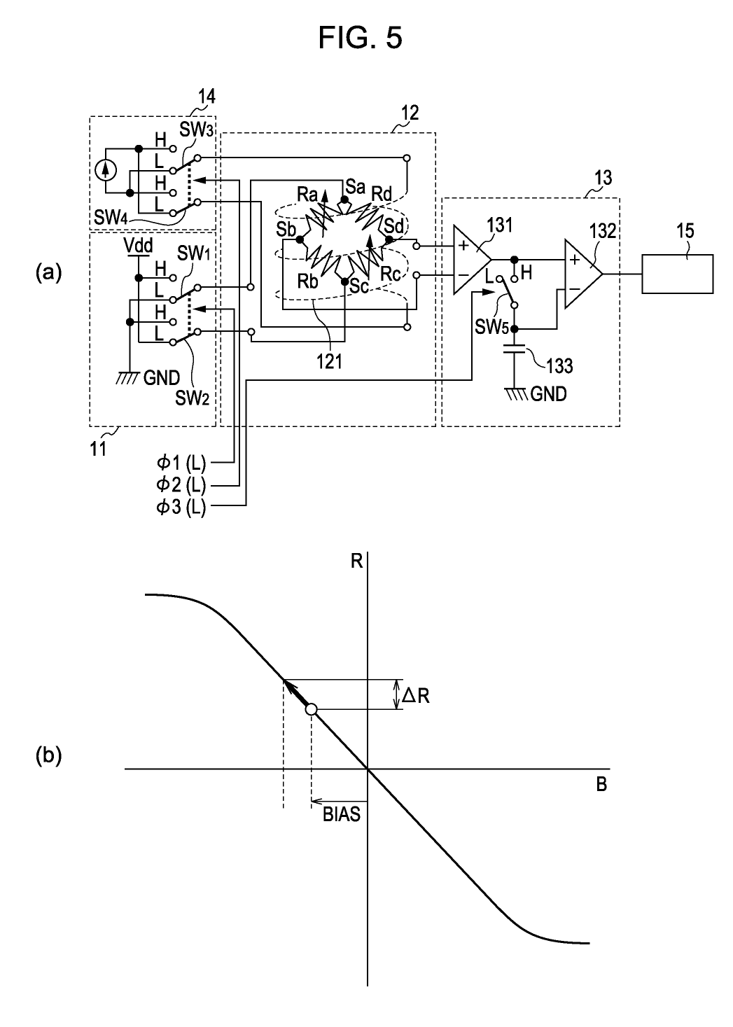

In stage S4, as shown in FIG. 5(a), the voltage to be applied to the sensor unit 12 is negative (the control signal φ1 is an L signal), and the bias magnetic field to be applied to the sensor unit 12 is negative (the control signal φ2 is an L signal). For this reason, the changes in resistance of the magnetoresistive element are as shown in FIG. 5(b). In stage S4, the control signal φ3 is an L signal, and the switch SW₅ does not cause the output of the amplifier 131 to be connected to the capacitor 133.

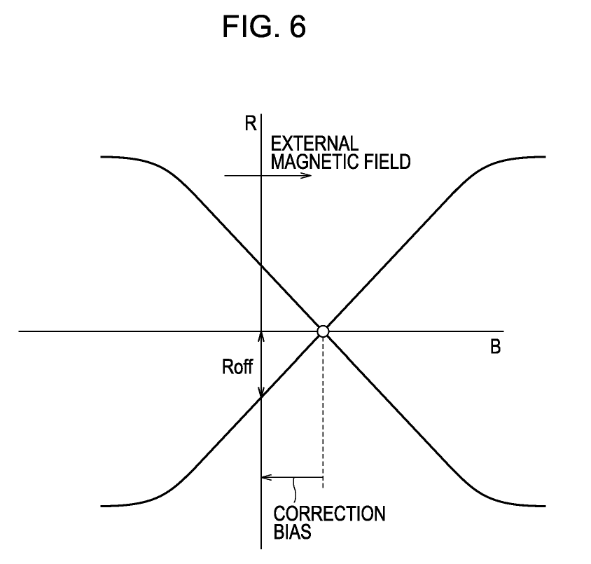

FIG. 6 illustrates the offset correction principle of the electronic compass according to the embodiment of the present invention. When an external magnetic field is applied to the sensor unit 12 for various causes (here, an offset voltage of the amplifier), as shown in FIG. 6, the characteristic curve does not pass through the intersection point of the resistance (voltage) and the magnetic field and is offset. That is, an offset voltage (Roff) occurs. In the present invention, in order to determine a correction value for canceling the offset voltage, the difference between the output voltages is determined from two stages (stages S1 and S3, or stages S2 and S4) in which the bias magnetic field is inverted, and the bias magnetic field is controlled until the difference becomes approximately zero.

More specifically, a first linear expression is determined on the basis of at least two output voltages that are obtained by applying a bias magnetic field to the sensor unit 12 in a state in which a first polarity (for example, positive) thereof is applied and inverted (here, the first linear expression is determined on the basis of stages S1 and S3). Next, a second linear expression is determined on the basis of at least two output voltages obtained by applying a bias magnetic field to the sensor unit 12 in a state in which a second polarity (for example, negative) thereof is applied and inverted (here, the second linear expression is determined on the basis of stages S2 and S4). Thereafter, the intersection point of the first linear expression and the second linear expression (the intersection point in FIG. 7) is determined. Then, the value from the magnetic field of the intersection point to the zero magnetic field is a correction value. That is, the corresponding bias magnetic field (electrical current value) when the difference between the output voltages becomes approximately zero is set as a correction value (correction bias). As a result, since correction can be performed even if an offset voltage is applied, it is possible to accurately perform magnetic detection.

Furthermore, in this electronic compass, it is possible to correct the sensitivity of the sensor unit 12 by using the first linear expression and the second linear expression. The linear expression shown in FIG. 6 can be represented as R=α·B±Roff. In this linear expression, α, which is an inclination, is determined. Therefore, by performing normalization using α (by determining ((k/α)·R (k: coefficient)), it is possible to correct the sensitivity of the sensor unit 12. By correcting the sensitivity of the sensor unit 12 in the above-described manner, it is possible to prevent a direction offset from occurring when the direction is to be computed.

In the above-described embodiment, a description has been given of a case in which an offset correction process is performed in the compass module 1. Alternatively, the offset correction process may be performed inside the compass module. For example, the controller inside the compass module 1 may include a determination unit for determining whether or not the difference between the output voltages is approximately zero on the basis of the detection result of the detector 13, and a specification unit for specifying the size of the bias magnetic field on the basis of the determination result of the determination unit, so that the bias magnetic field of the bias magnetic-field generator 14 is controlled.

When an offset correction process is to be performed in the compass module 1, the compass module 1 is configured to include a magnetic sensor for detecting a magnetic field, a bias magnetic-field generator for applying a bias magnetic field whose polarity is inverted to the magnetic sensor, a computation unit for determining the difference between the output voltages obtained with respect to the bias magnetic field of each polarity, and a correction unit for outputting to the bias magnetic-field generator a correction value with which the difference between the output voltages becomes approximately zero. In this case, the correction unit is configured to include a determination unit for determining whether or not the difference between the output voltages is approximately zero on the basis of the computation result of the computation unit, and a specification unit for specifying the size of the bias magnetic field on the basis of the determination result.

In such a configuration, when an offset correction process is to be performed by the controller inside the compass module 1, first, the specification unit of the controller specifies an electrical current value corresponding to the bias magnetic field to be applied and outputs the electrical current information to the bias magnetic-field generator 14. The bias magnetic-field generator 14 generates a bias magnetic field on the basis of the electrical current information. Then, as in stage S1, the voltage generator 11 sets the voltage to be positive (the control signal φ1: H), the bias magnetic-field generator 14 sets the bias magnetic field (the bias magnetic field corresponding to the electrical current value specified by the specification unit) to be positive (the control signal φ2: H), and the detector 13 determines the output voltage. Next, as in stage S3, the voltage generator 11 sets the voltage to be positive (the control signal φ1: H), the bias magnetic-field generator 14 sets the bias magnetic field (the bias magnetic field corresponding to the electrical current value specified by the specification unit) to be negative (the control signal φ2: L), and the detector 13 determines the output voltage.

The detector 13 determines the difference between these output voltages and outputs the difference information to the controller. In the controller, the determination unit determines whether or not the difference between the output voltages is approximately zero. When the difference between the output voltages is approximately zero, it follows that correction corresponding to the external magnetic field has been performed. Therefore, the specified bias magnetic field is output as a correction value to the bias magnetic-field generator 14. In the bias magnetic-field generator 14, magnetic detection is performed using this correction value. On the other hand, when it is determined in the determination unit that the difference between the output voltages is not approximately zero, correction corresponding to the external magnetic field has not been performed. Therefore, the determination unit outputs information to that effect to the specification unit. The specification unit sets an electrical current value differing from the previous electrical current value, and outputs the electrical current information to the bias magnetic-field generator 14. The amount of change of the electrical current value in the electrical current value differing from the previous electrical current value is set in such a manner that the difference between the output voltages approaches approximately zero. By performing such processing, a correction bias corresponding to an external magnetic field is determined, and the external magnetic field is cancelled, thereby making it possible to accurately perform magnetic field detection.

According to the present invention, a first linear expression is determined on the basis of at least two first output voltages obtained by applying to the magnetic sensor a bias magnetic field in a state in which a first polarity thereof is applied and inverted. A second linear expression is determined on the basis of at least two second output voltages obtained by applying to the magnetic sensor a bias magnetic field in a state in which a second polarity thereof is applied and inverted. A correction value is determined on the basis of an intersection point of the first linear expression and the second linear expression. As a consequence, it is possible to eliminate an offset voltage that is inevitably generated in a voltage output from the amplifier in the magnetic detection circuit. As a result, it is possible to accurately perform magnetic detection even in an environment in which a leakage magnetic field exists.

The present invention is not limited to the above-described embodiment, and can be changed variously and practiced. A case has been described in which, for example, only the offset voltage of the amplifier 132 is eliminated. According to the present invention, it is possible to eliminate an offset voltage that is generated due to a resistance balance of another amplifier and sensor. In addition, the present invention can be changed as appropriate and can be practiced without departing from the spirit and scope of the invention.

1. A computer-executable offset correction program for correcting an offset to be applied to a magnetic sensor, the offset correction program comprising:
the step of determining a first linear expression on the basis of at least two first output voltages obtained by applying to the magnetic sensor a bias magnetic field in a state in which a first polarity thereof is applied and inverted;
the step of determining a second linear expression on the basis of at least two second output voltages obtained by applying to the magnetic sensor a bias magnetic field in a state in which a second polarity thereof is applied and inverted; and
the step of determining a correction value on the basis of an intersection point of the first linear expression and the second linear expression.

2. The offset correction program according to claim 1, further comprising the step of performing sensitivity correction of the magnetic sensor by using the first linear expression and the second linear expression.

3. An electronic compass comprising: a compass module having a magnetic sensor; and control means having the offset correction program according to claim 1 for detecting the geomagnetism by using the output of the magnetic sensor and a direction computation program for determining a direction.

4. The electronic compass according to claim 3, wherein the magnetic sensor includes a magnetoresistive element that shows changes in resistance that occur monotonically with a magnetic field.

5. The electronic compass according to claim 4, wherein the magnetoresistive element is a GMR element.

6. The electronic compass according to claim 3, wherein the magnetic sensor is formed of a bridge circuit.

7. An electronic compass comprising: a compass module having a magnetic sensor; and control means having the offset correction program according to claim 2 for detecting the geomagnetism by using the output of the magnetic sensor and a direction computation program for determining a direction.
